(19) United States
(12) Patent Application Publication
(10) Pub. No.: US 2026/0315968 A1
(43) Pub. Date: Oct. 15, 2026

(54) COMPONENT OF A LIQUID FILTER FOR FILTERING LIQUIDS, AND LIQUID FILTER

(71) Applicant: Robert Bosch GmbH, Stuttgart (DE)

(72) Inventors: Poulose George Shinob, Gudalur (IN); Selvarajan Vijay Kumar, Tamilnadu (IN); David Manuel Hinojosa Garcia, Madrid (ES); Jan Semet, Vordersteinenberg (DE)

(21) Appl. No.: 19/163,255

(22) PCT Filed: Jun. 14, 2024
(86) PCT No.: PCT/EP2024/066501

§ 371 Date: Sep. 8, 2025

(30) Foreign Application Priority Data
Jun. 16, 2023 (DE) 10 2023 205 651.8

(51) Int. Cl. B01D 35/30; B01D 29/21

(52) U.S. Cl. CPC B01D 35/306; B01D 29/21; B01D 2201/295; B01D 2201/305; B01D 2201/4007; B01D 2201/4015; B01D 2201/4046; B01D 2201/4076; B01D 2201/4092

(57) ABSTRACT

A component for installation in a liquid filter for filtering liquids. The component includes a cover, a filter element which includes a filter medium, and a first end cap. The first end cap is between the filter medium and the cover. A latching arrangement includes a latching structure and a counter-latching structure, and is disposed between the first end cap and the cover. There is a maximum first clearance in a peripheral direction between the latching structure and the counter-latching structure. The latching structure is on the cover and the counter-latching structure is on the first end cap. A stop includes first and second stop structures. The first stop structure is disposed on the cover and the second stop structure is disposed on the first end cap. There is a maximum second clearance in the peripheral direction between the first stop structure and the second stop structure.

### FIELD

The present invention relates to a component configured for installation in a liquid filter for filtering liquids with a housing and a liquid filter.

BACKGROUND INFORMATION Liquid filters that are configured to filter a liquid are described in the related art. These include liquid filters for filtering a urea solution that are used in SCR (selective catalytic reduction) systems for exhaust gas purification, for instance. Such liquid filters are also referred to as Denox filters or AdBlue® filters or DEF (diesel exhaust fluid) filters. The removal of a filter element of the liquid filter, e.g. for maintenance purposes, often requires multiple steps, which makes removal and installation very time consuming and necessitates a variety of tools. Correct installation of a new filter element can also be complicated and prone to error. Contamination of the filter medium during installation of a new filter element is possible too, in particular on the clean side, if an installer accidentally touches the filter medium with his/her fingers.

A liquid filter comprising a filter element and a volume compensation device is described in German Patent Application No. DE 10 2017 011 278 A1.

### SUMMARY

A component according to the present invention, which is configured for installation in a liquid filter may have the advantage that simple installation of the component in the liquid filter is possible, and the component itself can easily and safely be preassembled to an assembly comprising a plurality of individual parts. The component can then be installed in the liquid filter as a preassembled assembly. This makes it possible to reduce installation errors during assembly. The component can also easily be removed from the liquid filter.

This may be achieved according to the present invention in that the component is configured for installation in a liquid filter for filtering liquids. According to an example embodiment of the present invention, the liquid filter comprises a housing. The component can in particular be installed in or into the housing of the liquid filter, e. g., pushed in and/or by means of a rotating movement or a screwing movement. The component includes a cover and a filter element, which comprises a filter medium, e.g. filter paper, melt-blown material or the like, and a first end cap and in particular a second end cap. The first end cap is disposed between the filter medium and the cover. The cover and the filter element are preferably captively coupled to one another.

In the context of this application, the term “liquid filter” also includes a so-called DNOX supply module or Denox supply module, wherein the component can be installed in the DNOX supply module, for instance, or in its housing. The cover of the component is then a cover that closes off an interior space of the DNOX supply module into which the filter element can be inserted, for example. For the sake of readability, however, only the term liquid filter is used in the following.

This captive coupling of the cover and the filter element, and in particular also a compensation element for compensating volume changes in the liquid to be filtered, e.g., as a result of ice formation, is in particular already in place before the component is installed on the housing of the liquid filter.

The component further comprises a latching arrangement with a latching structure and a counter-latching structure. The latching arrangement is disposed between the first end cap and the cover. Thus, when latched, the latching arrangement couples or connects the first end cap to the cover, in particular captively.

According to an example embodiment of the present invention, there is a maximum first clearance X in peripheral direction of the component between the latching structure and the counter-latching structure. The latching structure is disposed on the cover and the counter-latching structure is disposed on the first end cap. The component further includes a stop, which acts in particular at least in peripheral direction U and comprises a first stop structure and a second stop structure. The first stop structure is disposed on the cover and the second stop structure is disposed on the first end cap. A maximum second clearance Y in peripheral direction U is present or formed between the first stop structure and the second stop structure. To protect the latching arrangement, the first clearance X is greater than the second clearance Y, in particular at least 10% greater than the second clearance, preferably at least 15% greater than the second clearance and/or at least 0.05 mm, preferably at least 0.1 mm greater than the second clearance.

This prevents unwanted damage to the latching arrangement due to the smaller second clearance Y between the two stop structures when installing the cover on the filter element. The stop structures can in particular absorb a torque, for example, and prevent it from reaching the latching arrangement or reduce or limit the amount of torque input into the latching arrangement. The latching arrangement can thus be designed to be particularly simple, flexible and have a low wall thickness. This makes it possible to achieve a separation of functions. The latching arrangement can primarily absorb axial forces that can occur between the cover and the filter element or the first end cap, for instance. The stop or the stop structures can primarily absorb forces or torques in peripheral direction that can occur between the cover and the filter element or the first end cap, for example.

The clearance Y between the first and the second stop structure can in principle also be zero (0). The maximum clearance Y is then also zero. This has the effect that any rotation of the cover is transmitted directly to the filter element and does not affect the latching structure or the counter-latching structure. For the sake of manufacturability and/or tool wear during production and/or other manufacturing tolerances of the cover and/or the first end cap, however, the maximum clearance Y can also be greater than zero in order to prevent mechanical stresses between the first and the second stop structure.

The clearance in the peripheral direction between the latching structure and the counter-latching structure is advantageously greater than zero, because otherwise the latching between the latching structure and the counter-latching structure is difficult to achieve.

It goes without saying that the stop structures can also interact with one another in axial direction and can, for instance, prevent the cover from being pushed too far toward the first end cap when the cover is coupled to the end cap. For this purpose, according to an example embodiment of the present invention, the first and second stop structures can be configured such that, with a relative movement of the cover and the first end cap toward one another (e.g. along an axial direction), they come into mechanical contact or go solid before the latching structure goes solid in axial direction and/or before the counter-latching structure goes solid with the cover in axial direction.

According to an example embodiment of the present invention, the component preferably comprises a second end cap, which is disposed on the side of the filter element or the filter medium facing away from the cover. The filter medium of the filter element is disposed along an axial direction between the first and the second end cap and preferably comprises a hollow interior space. A compensation element can be disposed in the hollow interior space, for example.

In particular when using a compensation element, the captive coupling of the cover and the filter element end cap enables easy removal and installation. According to an example embodiment of the present invention, if the compensation element is part of the component as well, it is automatically removed or installed along with the other parts-it can in particular be captively coupled to the cover and/or the filter element or its first and/or second end cap. In any event, an installer then no longer has to touch the filter element with his/her fingers or use a dedicated removal tool during removal and/or installation, but can instead carry out removal/installation touching only the cover. The filter element and, if applicable, the compensation element are then removed at the same as the cover.

The captive coupling of the cover and the filter element, which includes the filter medium and the first end cap, moreover also enables correct positioning of the filter element, and preferably also a compensation element, without additional aids such as springs for pressing the filter element against the cover or the like. This makes it possible to save components and/or simplify the design of a housing for the liquid filter in which the component according to the present invention is used.

According to an example embodiment of the present invention, the first end cap can comprise a first opening. The compensation element can in particular be disposed in the interior space of the filter element. It can project at least partly into the interior space through the example first opening, for instance. It can also be inserted into the interior space through the first opening, for example.

A radial direction R extends perpendicular to an axial direction A. A peripheral direction U extends around the axial direction A.

The term “include” is used synonymously with the term “comprise”, unless stated otherwise.

Preferred further developments of the present invention are disclosed herein.

According to an example embodiment of the present invention, the cover preferably comprises a collar on which the latching structure and/or the first stop structure are disposed. This results in a very compact and robust structure. The collar can also protect the latching arrangement in the latched state from loosening the latching connection by preventing or hindering the effect of external forces on the latching structure and/or the counter-latching structure. The cover can furthermore be manufactured as an injection-molded component, for example, in which case the latching structure and the first stop structure can be manufactured at the same time as the cover.

According to another preferred configuration of the present invention, the first end cap comprises a groove in which the counter-latching structure and the second stop structure are disposed. The first end cap can thus in particular also be manufactured as an injection-molded component, in which case the groove, the counter-latching structure and the second stop structure can be manufactured at the same time as the first end cap. The groove preferably serves to accommodate the collar of the cover, which enables a very compact design in particular in axial direction A. For example, it can be provided that the collar is positioned further outward relative to the counter-latching structure viewed in radial direction. The latching arrangement is thus particularly easily protected or possible to protect from the effect of forces acting from radially outside. The captive coupling of the cover and the filter element can therefore no longer easily be released without destruction or can only be released non-destructively with considerable effort.

The collar of the cover preferably comprises a first and a second collar part. In peripheral direction U, a first intermediate space and a second intermediate space divide the collar to form the first and the second collar part. The collar parts preferably have the same configuration. The collar parts are further preferably arcuately shaped, in particular with the same arc length. The side surfaces bordering the first and/or second intermediate space and/or ends of the collar can serve as a second stop structure, for instance. The collar makes these stop structures very stable.

The first stop structure also preferably comprises two pairs of tower-like stop elements, wherein a respective pair of the stop elements terminates the first and the second collar part in peripheral direction. The two pairs of tower-like stop elements are each configured to accommodate a second stop structure of the first end cap between them in the installed state with the second clearance. Thus, tower-like stop elements are disposed in peripheral direction on the first and the second collar part, which are in particular manufactured at the same time as the collar parts, e.g., by injection molding.

If the first and the second collar part are arcuately shaped, the first and the second collar part preferably have an arc radius of at most 170°, in particular at most 120°, further preferably at most 100°and most particularly preferably at most 90°.

According to an example embodiment of the present invention, it can be provided, for instance, that the first stop structure is arcuately shaped on the first end cap, in particular circular ring sector shaped, or has such a cross-section. Such a first stop structure can cover a circumferential angle in the range of 10° to 90°, for example, preferably in the range between 20° and 80°, and particularly preferably in the range of 30° to 70°, e.g. 30° or 45° or 60°.

This creates a particularly stable stop, which is suitable for absorbing large torques without damage, in particular torques that can occur when the component rotates in the housing during installation or removal of the component into or out of the housing, in particular if a sealing element, such as an O-ring or the like, is disposed between the component and the housing.

This also advantageously facilitates correct installation of the component, in particular the cover on the filter element, because the first stop structure and the second stop structure have to mechanically engage with one another. This prevents errors during installation of the component.

According to an example embodiment of the present invention, the component also preferably comprises an axial stop with an axial stop structure which is disposed on the cover and serves to stop the first end cap in axial direction A of the cover. In the installed state of the first end cap on the cover, the axial stop structure can come into contact with the first end cap, in particular with the second stop structure on the first end cap, such that a minimum axial spacing Z is defined between the cover and the first end cap. This prevents damage to the two components during installation of the cover on the first end cap. If an axial displacement between the cover and the first end cap leads to the minimum axial spacing Z being undershot, the axial stop, for instance, goes solid with the first end cap, for example, with the second stop structure or with another part of the first end cap, which prevents the cover from coming any closer to the first end cap.

This can, for instance, reduce loading of the latching arrangement in axial direction during installation and/or during operation. Because of the ensured minimum axial spacing Z, said latching arrangement does not come into mechanical axial contact with the first end cap, in particular not a first distal and/or free end of the counter-latching structure with the first end cap or the latching structure with the cover. This prevents damage to the latching arrangement.

Another advantage is that this prevents excessive axial displacement of the cover toward the first end cap, which could undesirably bring a counter-latching structure, for instance configured as a latching tab, with a radially outer end of a latching window into contact with the latching structure, for instance configured as a latching tab, and thus cause the counter-latching structure to disengage from the latching structure.

Ensuring a minimum axial spacing Z, further advantageously makes it possible to prevent loading of an optional compensation element, e.g. by means of a connecting piece or collar of the first end cap. If the minimum axial spacing Z is undershot, a radial portion of the compensation element, for example, which is held clamped or is pinched in axial direction between the cover and the first end cap, could be subjected to excessive axial loading and in extreme cases punctured or plastically deformed or crushed.

According to an example embodiment of the present invention, the stop structure on the cover is preferably disposed in peripheral direction U at the first and the second intermediate space between the first stop structure or between its distal ends or between the first collar part and the second collar part. The stop structure is thus cleverly integrated into the cover without occupying additional installation space in axial direction.

According to an example embodiment of the present invention, the latching structure on the cover preferably comprises a projecting nose or a latching lug or a latching projection and the counter-latching structure comprises a complementarily configured recess on the first end cap. It should be noted that the projecting nose can also be provided on the first end cap and the complementarily configured recess on the cover. If there are a plurality of latching structures, it is also possible for the nose and the recess to be disposed alternately on the cover and the first end cap. The nose or the latching lug or the latching projection preferably points inward in radial direction. It can be disposed on an inward-facing wall of the collar, for example. This advantageously makes it more difficult to release the latch mechanism, so that the cover and the filter element are permanently captively connected to one another.

According to a particularly preferred configuration of the present invention, the component further comprises a compensation element which is disposed inside the filter element. The cover, the filter element and the compensation element are preferably captively coupled to one another, in particular prior to installation of the component in the liquid filter. The compensation element is thus an additional part of the component assembly, which further simplifies the removal and/or installation of the component on or in the liquid filter or on or in its housing.

The compensation element can be made of an elastic material or comprise an elastic material, for example, for instance a plastic or rubber. This deflection can be elastically reversible. It can comprise a hollow interior space. In other embodiment examples, it or its interior space can be filled with a material; for example with an in particular elastically reversible compressible material. For instance, it can be configured to at least partly absorb or compensate a volume change, e.g. resulting from a temperature-related volume change of liquid in the liquid filter, by means of compression, so that the filter element and/or the liquid filter is relieved of mechanical pressure caused by an increase in the volume of the liquid (e.g. during the transition from water to ice). It can comprise a compression body that extends in axial direction, for example. It can comprise a radial portion, for example, that extends in radial direction and adjoins the compression body.

According to an example embodiment of the present invention, the compensation element is particularly preferably connected to the end cap by means of a latching connection or a clip connection. It can be buttoned into the first end cap.

This makes it possible to achieve a secure attachment of the compensation element and also a redundant attachment of the compensation element to the component.

At least one latching device, e.g., at least one latching lug, can be disposed on the compression body extending in axial direction. This latching device can be configured such that it extends continuously around the compression body, for example. However, it is also possible to dispose exactly one or more latching lugs on the compression body, which are spaced apart from one another in peripheral direction.

The radial portion can be configured at a distal end of the compression body, for example in the manner of a mushroom cap. It can be provided that the radial portion comprises an opening through which a hollow interior space of the compression body is accessible.

Alternatively or additionally, the compensation element can be clamped on a radial portion of the compensation element in axial direction A of the component between the cover and the first end cap, in particular between the cover and an (end cap) collar in axial direction of the component. The radial portion can project, for example from a central body of the compensation element, in particular from a distal end of the central body, in radial direction, in particular transverse to an extension direction of the central body. The central body can extend in axial direction, for instance, and can comprise a hollow interior space, for example.

According to an example embodiment of the present invention, the (end cap) collar can be configured in the manner of a connecting piece, for example, or as a connecting piece or in the manner of a channel. It can, for instance, surround, delimit or define a through-opening in the first end cap.

This makes it possible to achieve a secure attachment of the compensation element and also a redundant attachment of the compensation element to the component.

The latching connection for fixing the compensation element to the end cap preferably comprises a latching lug. The latching lug can be provided all the way around the compensation element or alternatively only in sections around the periphery. The compensation element can thus be easily, securely and reliably installed in or on the filter element or coupled to it. For example, it can be buttoned into a through-opening in the first end cap. Such a latching connection or clip connection or buttoning into the through-opening can additionally be secured by an insert in the through-opening, for instance, as a result of which the compensation element is pinched or held clamped or secured in radial direction between the first end cap and the insert element. This can also improve the seal. Such an insert element can be realized with a cap element, for example, which is described in more detail in the following.

The latching structure and the counter-latching structure of the latching arrangement can interact with one another, for example like a clip connection. The latching arrangement, comprising the latching structure and the counter-latching structure, can, for instance, be configured such that a latching hook or a latching projection or a latching lug is provided on the cover as the latching structure. An undercut or a recess or a window is preferably disposed on the first end cap as the counter-latching structure, so that the latching hook or the latching projection or the latching lug is latched into the undercut or the recess or the window.

The cover is preferably made of a stiff plastic material, e.g., PA66, PA6, PPA or PBT or the like. The first end cap is preferably made of polypropylene.

According to an example embodiment of the present invention, the first and the second intermediate space, which are respectively present between the tower-like stop elements, preferably have an arc angle of at least 25°, preferably at least 30°, in peripheral direction. This results in a very stable structure, which makes it possible to absorb even relatively high torques that can occur, for example when the component is being screwed into the housing of the liquid filter.

The tower-like stop elements further preferably also have an extension in radial direction R that extends beyond a radial extension of the first and the second collar part. The tower-like stop elements in particular extend inward and/or outward in radial direction R beyond the first and the second collar part. The collar portions adjoining the tower-like stop elements further support the tower-like stop elements in peripheral direction.

The present invention thus makes it possible to protect the latching arrangement from damage, which could occur, for example, when the component is screwed into the liquid filter. Possible torques are absorbed by the first and the second stop structure and prevent damage to the latching arrangement.

The present invention also relates to a liquid filter comprising a housing and a component according to the present invention. The component in particular comprises a cover and a filter element with a first end cap, a filter medium and preferably a second end cap. It can also comprise a compensation element, for example, or a volume compensation element.

According to an example embodiment of the present invention, the housing of the liquid filter in particular comprises an inlet and an outlet. The housing and the above-described component are preferably releasably connected to one another, e.g., by means of a screw connection. The liquid filter according to the present invention is easy to maintain and cost-efficient to manufacture and exhibits a particularly small risk of contamination. Incorrect installation (e.g. forgetting the filter element or forgetting the compensation element or incorrectly installing one of the elements in the housing) of a liquid filter (e. g. removed for maintenance purposes) is practically impossible. Further advantages emerge from the above description.

The liquid filter, for which the component is configured for installation, can comprise a heater or heating element, which is/are disposed on and/or in the housing, for example.

### BRIEF DESCRIPTION OF THE DRAWINGS

A preferred design example of the present invention is described in detail in the following with reference to the figures.

FIG. 1 shows a schematic longitudinal section through a component for a liquid filter according to a preferred embodiment example of the present invention from a first perspective in an exploded view.

FIG. 2 shows a schematic longitudinal section of the component of FIG. 1 from a second perspective in an exploded view.

FIG. 3 shows a schematic longitudinal section of the component of FIG. 1 from a further perspective in an exploded view.

FIG. 4 shows a further schematic longitudinal section of the component of FIG. 1 from a further perspective in an exploded view.

FIG. 5 shows a schematic longitudinal section through a liquid filter comprising a component for the liquid filter according to FIG. 1.

FIG. 6 shows a schematic longitudinal section through the liquid filter of FIG. 5 in a different sectional axis.

FIG. 7 shows a schematic perspective view of an underside of a cover of the component of FIG. 1 that faces the first end cap.

FIG. 8 shows a perspective view of an upper side of the first end cap of the component of FIG. 1 that faces the cover.

FIG. 9 shows a schematic plan view of the cover of FIG. 7 onto the underside of the cover.

FIG. 10 shows a schematic plan view onto the upper side of the first end cap of FIG. 8.

FIG. 11 shows a schematic illustration of a first clearance of a latching connection between the first end cap and the cover, according to an example embodiment of the present invention.

FIG. 12 shows a schematic illustration of a second clearance between the end cap and the cover, according to an example embodiment of the present invention.

FIG. 13 shows a schematic perspective view of the component of FIG. 1 with the cover from above.

FIG. 14 shows a schematic perspective view of the component of FIG. 1 without the cover.

FIG. 15 shows a schematic partial sectional view of the component of FIG. 1 in a further sectional plane.

### DETAILED DESCRIPTION OF EXAMPLE EMBODIMENTS

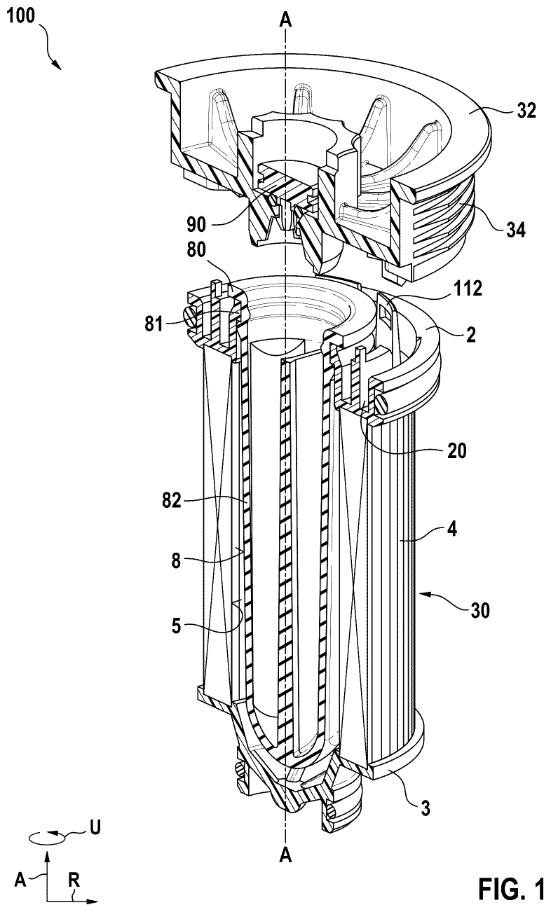

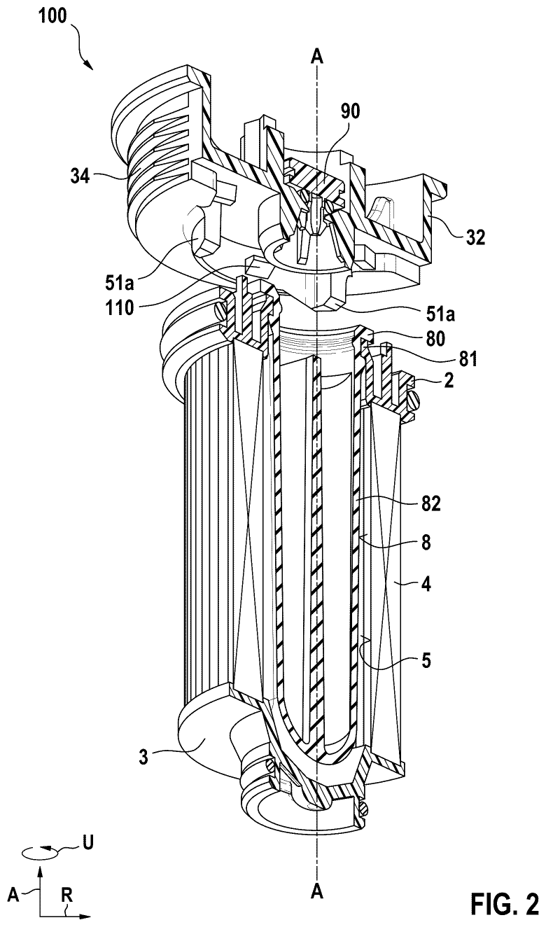

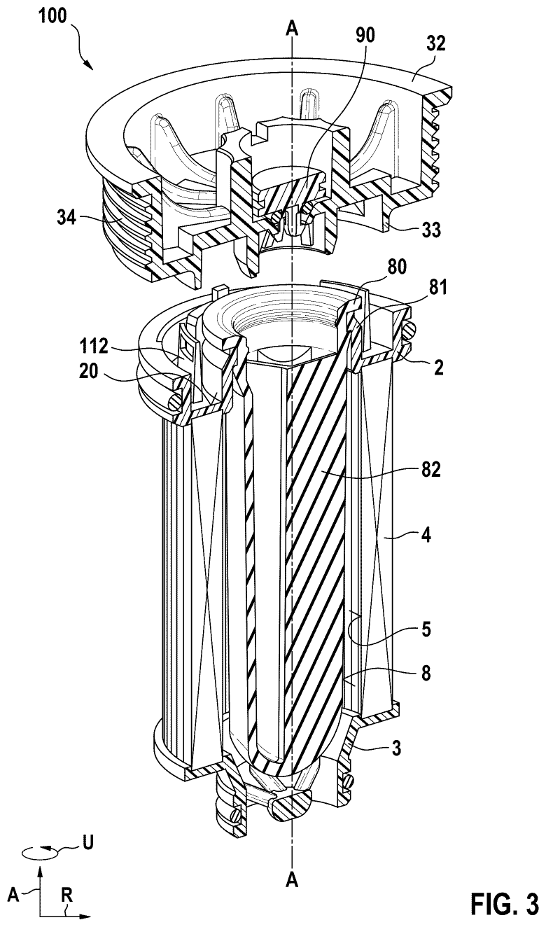

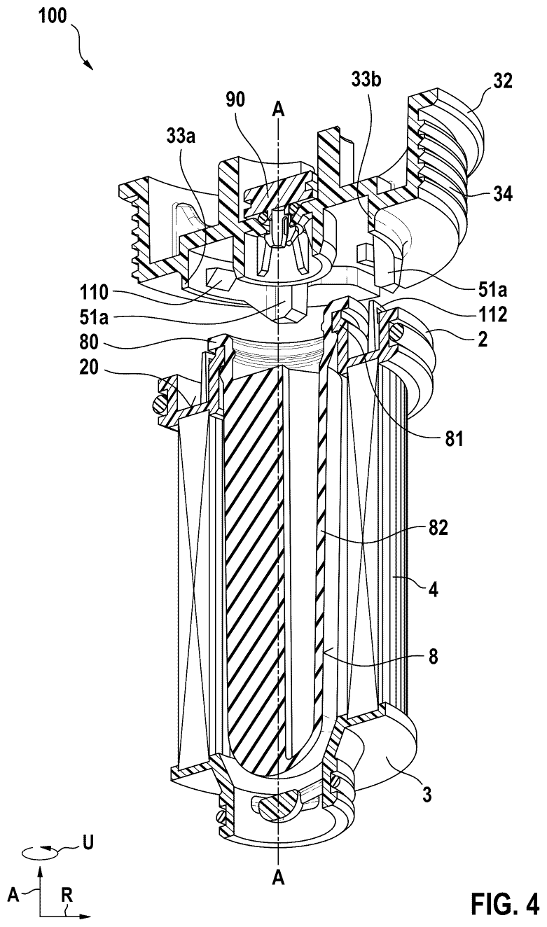

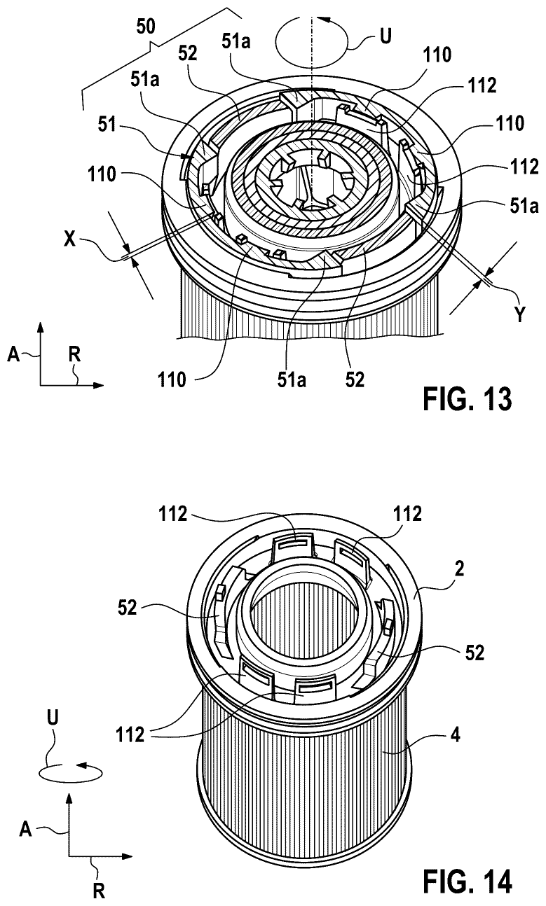

A component 100 and a liquid filter 1 according to a preferred embodiment example of the present invention are described in detail in the following with reference to FIGS. 1 to 15.

FIGS. 1 to 4 show a component 100 configured for installation in a liquid filter 1 in detail.

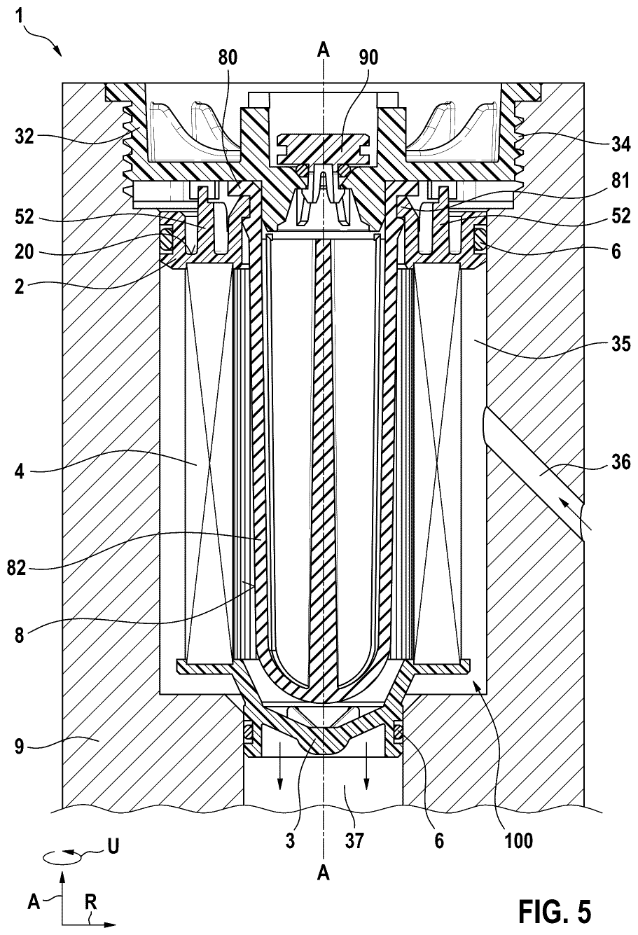

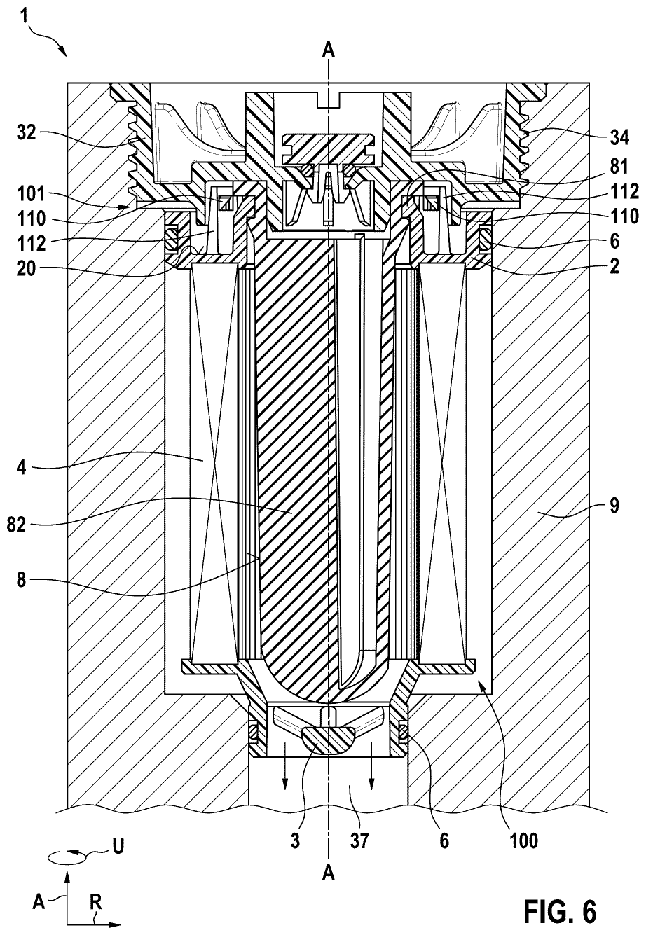

FIGS. 5 and 6 show the liquid filter 1 with the component 100 installed or assembled. The component 100 is installed in a housing 9 of the liquid filter 1. The housing 9 comprises an inlet 36 (in this example from the side) and an outlet 37 (in this example at a distal end of the housing 9). The housing 9 also defines an interior space 35 in which the component 100 is accommodated.

A liquid fed in via the inlet 36—in this example from radially outside (raw side)—is passed through a filter medium 4, for example a paper filter or the like, which is in this example is hollow cylindrical-in this example to radially inside (clean side)-and guided through the component 100 to the outlet 37 from which the now filtered liquid emerges.

As can be seen in FIGS. 5 and 6, the filter medium 4 is disposed in the interior space 35 parallel to an axial direction A. The liquid passes through the filter medium 4 in a radial direction R. U denotes a peripheral direction about the axial direction A.

The component 100 in this embodiment example comprises a filter element 30 with a first end cap 2, a second end cap 3, which is provided here as an example, and the filter medium 4. The component 100 also includes a cover 32 and a compensation element 8 (which is provided here only as an example) or comprises these components. The component 100 forms a pre-assemblable assembly. The cover 32 and the filter element 30, as well as the optional compensation element 8, are coupled or connected to one another as a captive unit, here in the form of the component 100, in particular before being installed in the housing 9. In this example, the compensation element 8 comprises a central body 82 which extends in axial direction and a radial portion 80 which extends in radial direction R and is disposed at a distal end of the central body 82.

The component 100 is screwed into the housing 9 of the liquid filter 1 by means of a thread 34 on the cover 32, for example. Two O-rings 6 on the first and the second end cap 2, 3 seal the component 100 against an inner wall of the housing 9. In conjunction with the housing 9, these two O-rings 6 create an internal seal and thus prevent a fluidic short circuit between the raw side and the clean side of the filter element 30. The O-ring 6 on the first end cap 2 at the same time creates an external seal. It prevents fluid (in this example from the raw side) from entering an exterior space of the liquid filter 1.

The filter medium 4 is disposed in axial direction A between the first end cap 2 and the second end cap 3. The first end cap 2 is also coupled or connected to the cover 32.

The filter medium 4 as well as the first end cap 2 and the second end cap 3 are parts of the filter element 30 as described above. The filter element 30 is interchangeable as a unit (in particular together with the cover 32 as a type of handle).

The compensation element 8 comprises a latching lug, which can be buttoned in on the first end cap 2. The compensation element 8 can also additionally or exclusively be clamped-in particular with a radial portion 80 which extends in radial direction-between the cover 32 and the first end cap 2, in particular at an (end cap) collar 81 or connecting piece, of the first end cap 2. A cap element 90 is disposed on the cover 32 and is configured to prevent the penetration of dirt, debris, insects, and/or moisture into the interior of the compensation element 8. The cap element 90 enables gas exchange between the interior space of the compensation element 8 and the outside environment, for instance. This can be a membrane, for example, through which gas exchange is possible.

The filter medium 4 can be star-pleated, for example, and can, for instance, be made of filter paper, melt-blown material, or the like. The filter medium 4 has a substantially cylindrical hollow interior space 5, in which the compensation element 8 is disposed.

As can be seen in FIGS. 1 to 4, a filter element 30 comprises the filter medium 4 and at least the first end cap 2; preferably also the second end cap 3. The first end cap 2 is disposed in axial direction A between the filter medium 4 and the cover 32. The filter medium 4 is disposed in axial direction A between the first end cap 2 and the second end cap 3. The compensation element 8 can be disposed at least partly (e.g. with its radial portion) in axial direction A between the first end cap 2 and the cover 32.

To connect the cover 32 to the end cap 2, a latching arrangement 101 (see FIG. 6, for example) is provided between the first end cap 2 and the cover 32. The latching arrangement 101 comprises a latching structure 110 and a counter-latching structure 112.

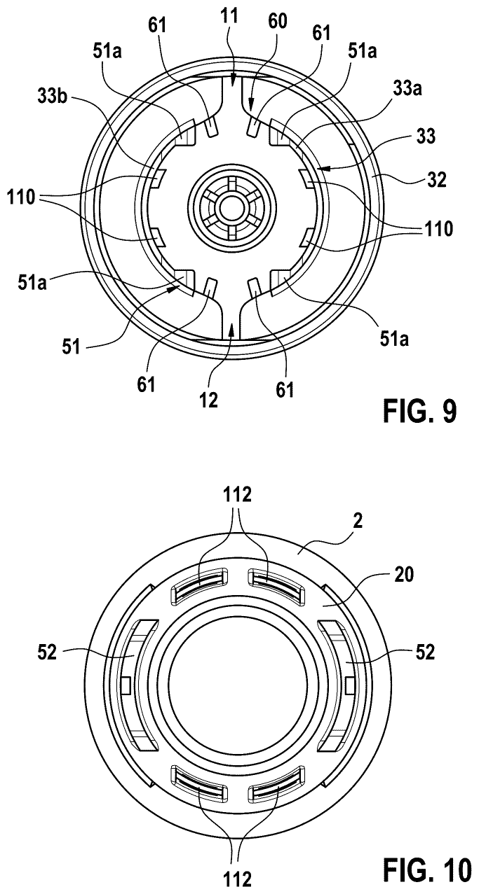

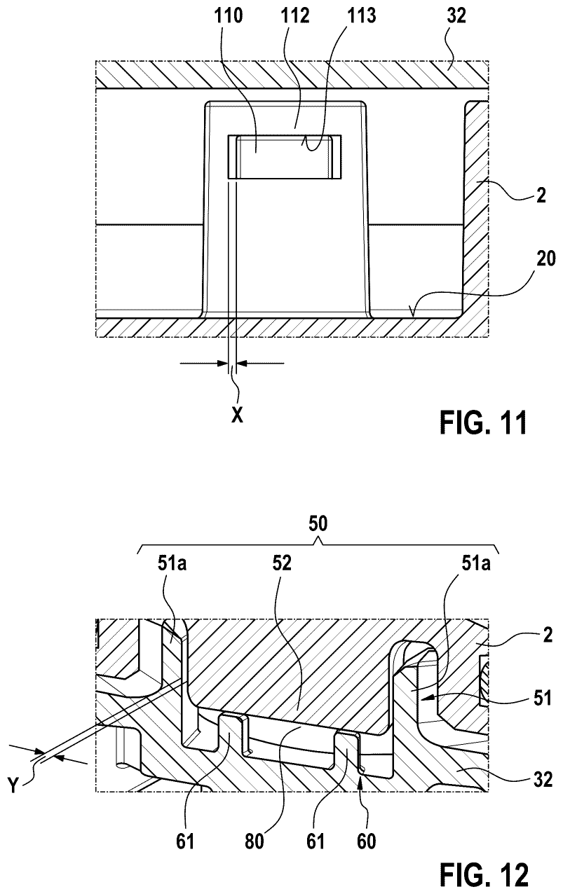

The latching arrangement 101 can in particular be seen in FIGS. 6, 9 and 10. As shown as an example in FIG. 9, four latching structures 110 in the form of projecting noses are disposed on the cover 32 (in principle, a single latching structure 110 may be sufficient or two or three or more than four latching structures 110 can be provided). Correspondingly, four counter-latching structures 112 in the form of tabs with windows 113 are formed on the first end cap 2 as an example (see also FIG. 8 and FIG. 11). It should be noted that the cover 32 from FIG. 9 is advantageously placed on the first end cap 2 in FIG. 10 rotated 90° for installation.

It should be noted that the latching arrangement 101 can also be provided in reverse; i.e. the recesses and/or tabs with windows are provided on the cover 32 and the noses are provided on the first end cap 2.

The latching structure 110 and the counter-latching structure 112 are configured such that a maximum first clearance X in peripheral direction U is present and/or formed between the latching structure 110 and the counter-latching structure 112. This can be seen in detail in FIG. 11.

A stop 50 with a first stop structure 51 and a second stop structure 52 is provided as well. This can be seen in detail in FIG. 12. The first stop structure 51 is disposed on the cover 32 and the second stop structure 52 is disposed on the first end cap 2. A maximum second clearance Y in peripheral direction U is present or formed between the first stop structure 51 and the second stop structure 52. This can be seen in detail in FIG. 12. To protect the latching arrangement 101, the first clearance X is greater than the second clearance Y.

Because the first clearance X is greater than the second clearance Y, the latching arrangement 101 is protected from damage, in particular from loads or forces acting in peripheral direction and/or torques between the cover and the filter element. When screwing the component 100 on the cover 32 into the housing 9, for example, a torque can be exerted on the component 100, which, if handled improperly or due to the friction of the O-rings 6 on the housing 9 or excessive force, exposes the latching arrangement 101 to very high loads. To avoid damage, without the stop 50, an increased wall thickness or a larger dimensioning of the latching arrangement 101 could be necessary, but this would increase costs and impair the flexibility of the latching arrangement 101. The stop 50 can also absorb or reduce shocks or vibrations that act on the liquid filter 1 (e.g. when driving over rough terrain or the like), so that they do not act on the latching arrangement 101, or do so not at full strength. Damage to the latching arrangement 101 must be avoided in order to enable safe and reliable removal of the entire component 100 (in particular the filter element 30 of the component) for maintenance purposes. The clever design of the latching arrangement 101 with a peripheral clearance that is greater than a peripheral clearance of the stop 50 reliably prevents damage to the latching arrangement 101 or the stop 50 can safely and reliably protect the latching arrangement 101 from excessive force.

To reliably protect the latching arrangement 101, the first clearance X is preferably at least 10% greater than the second clearance Y. Alternatively or additionally, the first clearance X is at least 0.05 mm, preferably at least 0.1 mm greater than the second clearance. The difference between the first clearance X and the second clearance Y can be 0.12 mm or 0.14 mm or 0.16 mm, for instance. It can be 20% or 30% or 40% or 50% or 60%, for example, or even greater percentage deviations.

In principle, it can be provided that the second clearance Y is zero (0); i.e. the first stop structure 51 and the second stop structure 52 are in mechanical contact with one another. This enables particularly good load relief for the latching arrangement 101 in peripheral direction U.

This makes it possible to prevent loads on the latching arrangement 101 both during assembly of the component 100 and during installation of the component 100 into the liquid filter 1. The component 100 can be preassembled outside the housing 9 and then the cover 32 together with the filter element 30 (and the compensation element 8) can be installed in the housing 9 by sliding and/or rotating. This installation process also differs from the related art, because the filter element 30 is typically inserted into the housing 9 and is then fixed by screwing the cover 32 onto the housing 9. In the related art, this results in the described hazards to the latching arrangement or other parts of component 100.

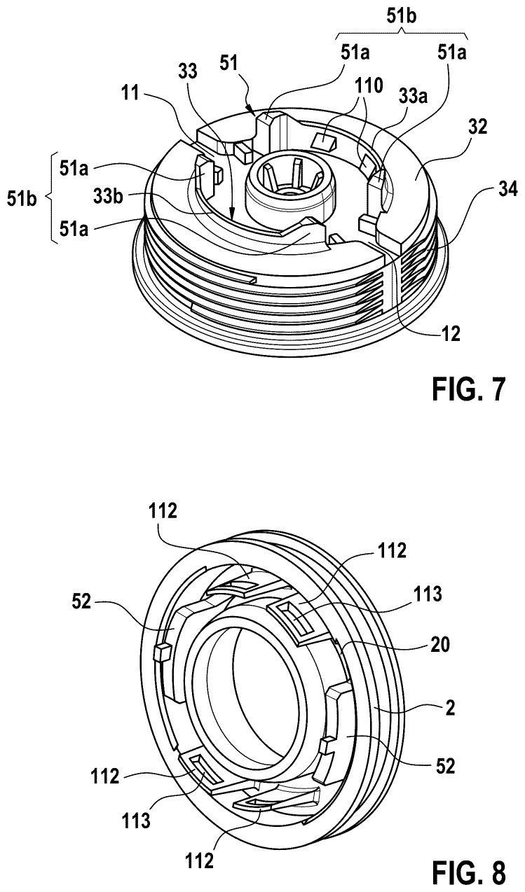

In order to provide a structure that is as compact as possible, the cover 32 comprises a collar 33. The collar 33 comprises a first collar part 33a and a second collar part 33b. As can be seen in FIG. 9, the first and the second collar part 33a, 33b are disposed opposite one another on the cover 32 on the side facing the first end cap 2 and in this example have the same structure. A first intermediate space 11 and a second intermediate space 12 are provided in peripheral direction, between the first collar part 33a and the second collar part 33b. The first and the second intermediate space 11, 12 are likewise disposed opposite one another on the cover 32. In this embodiment example, the first stop structure 51 is provided with two pairs 51b of tower-like stop elements 51a (see FIG. 7). A respective pair 51b of the stop elements 51a terminates the first and the second collar part 33a, 33b in peripheral direction U.

The two pairs 51b of tower-like stop elements 51a are each configured to accommodate the second stop structure 52 of the first end cap 2 between them in the installed state with the second clearance Y.

The tower-like stop elements 51a have an extension in both axial direction A via the collar parts 33a, 33b and in radial direction R via the collar parts 33a, 33b, which have a relatively thin wall thickness.

As can be seen in FIGS. 8 and 10, the first end cap 2 comprises a groove 20 in which the counter-latching structures 112 and the second stop structures 52 are disposed. This results in a short structure in axial direction A when the first end cap 2 and the cover 32 are connected to one another. In the installed state of the component 100, this also prevents the latching arrangement 101 from being released again, or at least makes it more difficult to release the latching arrangement 101. This prevents incorrect operation by a user. The component 100 can be delivered to the user preassembled by a manufacturer, for example, so that quality control of the correct installation of the component 100 can be ensured prior to delivery. The user can then install the preassembled component 100 into the housing 9 of the liquid filter 1 him/herself without any further installation steps on the component 100. This also ensures correct cleaning performance by the filter element 30 or the liquid filter 1 (accidental installation of only the cover 32 without the filter element 30 is thus prevented).

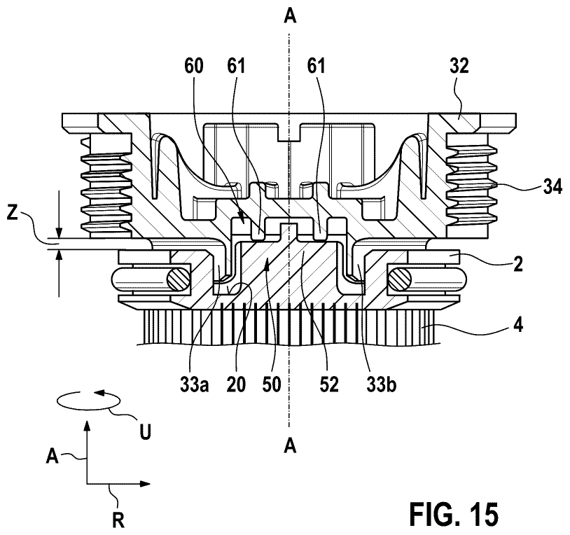

To also avoid axial shocks on the latching arrangement 101, the component 100 further comprises an axial stop 60. The axial stop 60 comprises an axial stop structure 61 disposed on the cover 32 and serves to stop the first end cap 2 in axial direction A of the cover 32. In the installed state of the first end cap 2 on the cover 32, the axial stop structure 61 can, as shown here, for example, come into contact with the second stop structure 52 on the first end cap 2 (or with another element of the first end cap 2), such that a defined or minimum axial spacing Z is formed or defined between the cover 32 and the first end cap 2. The axial spacing Z can be seen in FIG. 15. If a force acts in axial direction A on the cover 32 in the direction the filter element 30, for example, the cover 32 goes solid by means of the axial stop structure 61 after an axial travel that would exceed the minimum axial spacing Z. Further axial displacement is not possible. This protects not only the latching arrangement 101 but also the radial portion of the compensation element 8. If the minimum axial spacing Z were undershot (without the axial stop 60), the radial portion of the compensation element 8 could be (excessively) squeezed or even punctured, for example. As can clearly be seen in FIG. 6, a distal or free end of the counter-latching structure 112 could also run into the first end cap 2 and, if the axial spacing were to be reduced further, the counter-latching structure 112 could be damaged. A radially outer side of the counter-latching structure 112 could furthermore run onto the slope of the latching structure 110 and thus displace the counter-latching structure 112 radially inward. This would cause the latching structure 110 and the counter-latching structure 112 to disengage and possibly deform plastically. Rotating the cover 32 back would not reliably guarantee that the filter element 30 is securely connected to the cover 32 in axial direction A and could be removed from the liquid filter 1 together with the cover 32. Thus, in this embodiment, the minimum axial spacing Z prevents the counter-latching structure 112 from coming into (axial) contact with the first end cap 2 with its distal end and/or prevents the counter-latching structure 112 from disengaging from the latching element 110, in particular due to a radial displacement.

The second end cap 3 further comprises an opening through which the filtered liquid can flow, which then enters the outlet 37 and is discharged.

The liquid filter 1 can be a Denox liquid filter or an AdBlue® liquid filter or a DEF liquid filter, for example. Such a Denox liquid filter is used in an SCR system, for instance, and, for example, filters aqueous urea solutions for exhaust aftertreatment for an internal combustion engine.

### REFERENCE SIGNS

1 Liquid filter
100 Component
2 first end cap
3 Second end cap
4 Filter medium
5 Hollow interior space
6 O-rings
8 Compensation element
9 Housing
11 First intermediate space
12 Second intermediate space
20 Groove on the first end cap
30 Filter element
32 Cover
33 Collar
33a First collar part
33b Second collar part
34 Thread
35 Interior space
36 Inlet
37 Outlet
50 Stop
51 First stop structure on the cover
51a Tower-like stop elements
51b Pair of tower-like stop elements
52 Second stop structure at the first end cap
60 Axial stop
61 Axial stop structure
80 Radial portion of the compensation element
81 (End cap) collar or connecting piece
82 Central body
90 Cap element
101 Latching arrangement
110 Latching structure on the cover
112 Counter-latching structure on the first end cap
113 Window
A Axial direction
R Radial direction
U Peripheral direction
X First clearance
Y Second clearance
Z Minimum axial spacing between the cover and the first end cap

1-10. (canceled)

11. A component configured for installation in a liquid filter for filtering liquids with a housing, wherein the component comprises:
a cover;
a filter element which includes a filter medium and a first end cap, wherein the first end cap is disposed between the filter medium and the cover;
a latching arrangement including a latching structure and a counter-latching structure, wherein the latching arrangement is disposed between the first end cap and the cover;
wherein there is a maximum first clearance in a peripheral direction between the latching structure and the counter-latching structure;
wherein the latching structure is disposed on the cover and the counter-latching structure is disposed on the first end cap; and
a stop including a first stop structure and a second stop structure;
wherein the first stop structure is disposed on the cover and the second stop structure is disposed on the first end cap;
wherein there is a maximum second clearance in the peripheral direction between the first stop structure and the second stop structure; and
wherein, to protect the latching arrangement, the first clearance is greater than the second clearance by at least 10% and/or by at least 0.05 mm.

12. The component according to claim 11, wherein the cover includes a collar on which the latching structure and/or the first stop structure are disposed.

13. The component according to claim 11, wherein the first end cap includes a groove in which the counter-latching structure and the second stop structure are disposed.

14. The component according to claim 12, wherein:
the collar of the cover includes a first collar part and a second collar part which are separated in the peripheral direction by a first intermediate space and a second intermediate space; and
the first stop structure includes two pairs of tower-like stop elements, wherein a respective pair of the tower-like stop elements terminates the first and the second collar part in peripheral direction and the two pairs of the tower-like stop elements are each configured to accommodate a second stop structure of the first end cap between them in an installed state with the second clearance.

15. The component according to claim 14, further comprising:
an axial stop with an axial stop structure which is disposed on the cover and serves to stop the first end cap in an axial direction of the cover;
wherein, in an installed state of the first end cap on the cover, the axial stop structure can come into contact with the second stop structure on the first end cap, such that a minimum axial spacing is defined between the cover and the first end cap.

16. The component according to claim 15, wherein the axial stop structure is disposed on the cover in the peripheral direction at the first intermediate space and the second intermediate space between the first stop structure.

17. The component according to claim 11, wherein the latching structure on the cover includes a projecting nose and the counter-latching structure on the first end cap is formed as a complementarily configured recess.

18. The component according to claim 11, further comprising:
a compensation element disposed inside the filter element;
wherein the cover, the filter element and the compensation element are captively coupled to one another, prior to installation of the component in the liquid filter.

19. The component according to claim 18, wherein:
the compensation element is connected to the first end cap using a latching connection, and/or
the compensation element is clamped at a radial portion of the compensation element between the cover and the first end cap in an axial direction of the component.

20. A liquid filter, comprising:
a component including:
a cover,
a filter element which includes a filter medium and a first end cap, wherein the first end cap is disposed between the filter medium and the cover,
a latching arrangement including a latching structure and a counter-latching structure, wherein the latching arrangement is disposed between the first end cap and the cover,
wherein there is a maximum first clearance in a peripheral direction between the latching structure and the counter-latching structure,
wherein the latching structure is disposed on the cover and the counter-latching structure is disposed on the first end cap, and
a stop including a first stop structure and a second stop structure,
wherein the first stop structure is disposed on the cover and the second stop structure is disposed on the first end cap,
wherein there is a maximum second clearance in the peripheral direction between the first stop structure and the second stop structure, and
wherein, to protect the latching arrangement, the first clearance is greater than the second clearance by at least 10% and/or by at least 0.05 mm; and
a housing, wherein the component is installed in the housing using of a screw connection, detachably as a subassembly.
